(19) United States
(12) Patent Application Publication
(10) Pub. No.: US 2010/0135160 A1
(43) Pub. Date: Jun. 3, 2010

(54) SYSTEM AND METHOD FOR ELECTRONIC MONITORING

(75) Inventors: Manho PARK, Daejeon (KR); Song In Choi, Daejeon (KR); Byungsik Yoon, Daejeon (KR); Jee Hwan Ahn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/628,440

(22) Filed: Dec. 1, 2009

(30) Foreign Application Priority Data
Dec. 2, 2008 (KR) 10-2008-0121420
Aug. 27, 2009 (KR) 10-2009-0080046

(51) Int. Cl. H04L 12/26; G08B 21/00

(52) U.S. Cl. 370/241; 340/540; 340/3.1

(57) ABSTRACT

A system for electronic monitoring includes a control server and a plurality of monitoring servers. The control server transmits electronic monitoring instructions including identification information on terminals to a plurality of monitoring servers, respectively, based on information of objects to be monitored stored in a database, receives an object confirmation request message including information on suspect object packets from a first monitoring server among the plurality of monitoring servers, and determines whether the monitoring object terminals correspond to suspect object terminals that transmit or receive the suspect object packets according to the object confirmation request message based on the information on the monitoring objects. When the suspect object terminals are the monitoring object terminals, the control server updates the database based on the information on the suspect object packets.

### CROSS-REFERENCE TO RELATED APPLICATION

This application claims priority to and the benefit of Korean Patent Application No. 10-2008-0121420 and 10-2009-0080046 filed in the Korean Intellectual Property Office on Dec. 2, 2008 and Aug. 27, 2009, the entire contents of which are incorporated herein by reference.

### BACKGROUND OF THE INVENTION

(a) Field of the Invention

The present invention relates to a system and method for electronic monitoring. In particular, the present invention relates to an apparatus and method for electronic monitoring in a packet communication system.

(b) Description of the Related Art

When a law enforcement agency requests electronic monitoring for specific objects, communication service providers collect information on communication records, information on communication contents, etc. of electronic monitoring objects requested by the law enforcement agency, and provide the collected information to the law enforcement agency.

However, as a communication scheme is being developed from a voice communication scheme to a packet communication scheme, the packet communication systems use different communication schemes or different encryption schemes, such that it is difficult to perform the electronic monitoring. Further, it is difficult to perform continuous electronic monitoring while providing mobility to users.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for electronic monitoring that is capable of performing continuous electronic monitoring on objects to be monitored in a packet communication system that provides mobility to a user.

A method for performing electronic monitoring according to an exemplary embodiment of the present invention is a method for performing electronic monitoring on a terminal by a system, wherein the system includes a plurality of monitoring servers that monitor a control server and a plurality of communication systems, respectively. The method for electronic monitoring includes: transmitting an electronic monitoring instruction including identification information on the terminal to be monitored to each of the plurality of monitoring servers by the control server based on information on monitoring objects stored in a database; receiving an object confirmation request message including information on a suspect object packet from a first monitoring server of the plurality of monitoring servers by the control server; determining whether the terminal corresponds to a suspect object terminal that transmits or receives the suspect object packet according to the object confirmation request message by the control server based on the information on the monitoring objects; and when the suspect object terminal is the terminal, updating the database by the control server based on the information on the suspect object packet.

At this time, the method for performing electronic monitoring further includes transmitting monitoring object notification messages notifying that the suspect object terminal is the terminal to the first monitoring server by the control server, and receiving the suspect object packets from the first monitoring server. by the control server.

Further, the updating includes registering the additional identification information on the terminal in the database and updating the database by the control server based on the information on the suspect object packets, wherein the suspect object notification message includes the additional identification information on the terminal.

In addition, the method for performing electronic monitoring further includes transmitting the additional identification information on the terminal to the plurality of monitoring servers by the control server.

Moreover, the method for performing electronic monitoring further includes, when the suspect object terminal is not the terminal, transmitting a monitoring non-object notification message notifying that the suspect object terminal is not the terminal to the first monitoring server by the control server.

A method for performing electronic monitoring according to another exemplary embodiment of the present invention is a method for performing electronic monitoring on a terminal by a system, wherein the system includes a plurality of monitoring servers that monitor a control server and a plurality of communication systems, respectively. The method for performing electronic monitoring includes: receiving an electronic monitoring instruction including the identification information on the terminal to be monitored from the control server by a first monitoring server of the plurality of monitoring servers; performing the electronic monitoring on a plurality of packets transmitted through a plurality of terminals accessing a first communication system of a plurality of communication systems and the first communication system according to the electronic monitoring instruction by the first monitoring server to detect a suspect object packet; sending an object confirmation request message including the information on the suspect object packet to the control server by the first monitoring server and requesting to the control server whether the suspect object terminal transmitting or receiving the suspect object packet corresponds to the terminal; and when receiving the monitoring object notification message from the control server, transmitting the suspect object packet to the control server by the first monitoring server.

At this time, the monitoring object notification message includes the additional identification information on the terminals, wherein the method for performing electronic monitoring further includes performing the electronic monitoring according to the electronic monitoring instruction and the additional identification information of the terminal by the first monitoring server.

Further, the detecting includes temporarily storing the suspect object packets, wherein the method for performing electronic monitoring further includes destroying the temporarily stored suspect object packets by the first monitoring server when receiving monitoring non-object notification messages from the control server.

In addition, the suspect object packet is a packet that is suspected as being communicated by the terminal using forgery or false-name ID or a packet that includes the information on the terminal among the communication contents.

A system for electronic monitoring according to yet another embodiment of the present invention is a system for performing electronic monitoring according to information of an object to be monitored. The system for electronic monitoring includes a plurality of electronic monitoring apparatuses. The plurality of electronic monitoring apparatuses correspond to each of the plurality of communication systems, and perform the electronic monitoring according to the information of object to be monitored based on a deep packet check technology. Any one of the plurality of electronic monitoring apparatuses performs the electronic monitoring on the plurality of packets transmitted through a plurality of terminals accessing any one of a plurality of communication systems and the communication systems.

At this time, the system for electronic monitoring further includes a control device. The control device registers the information of objects to be monitored in the database, transmits the information of object to be monitored to each of the plurality of electronic monitoring apparatuses, and updates the database based on information on a suspect object packet received from any one of the plurality of electronic monitoring apparatuses.

### BRIEF DESCRIPTION OF THE DRAWINGS

FIG. 1 is a diagram showing a system for electronic monitoring according to an exemplary embodiment of the present invention; and

FIG. 2 is a diagram showing a method for performing electronic monitoring according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

Hereinafter, a method for performing electronic monitoring according to an exemplary embodiment of the present invention will be described.

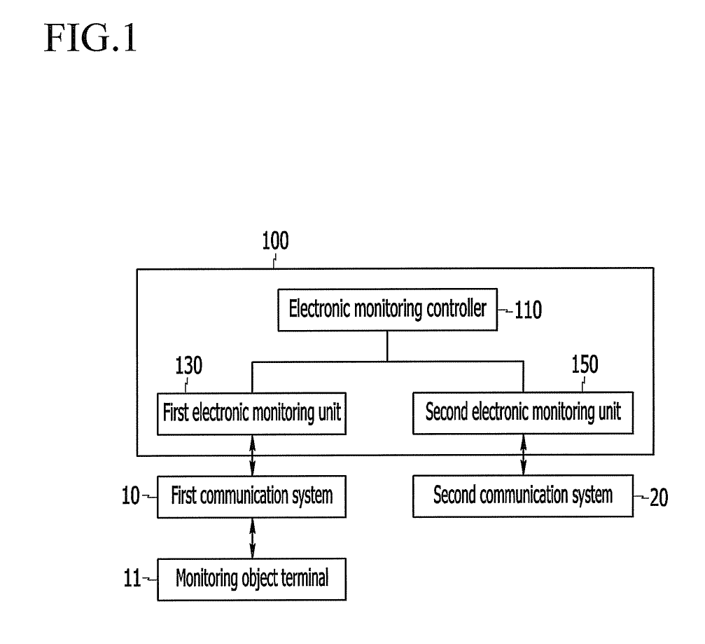

Referring first to FIG. 1, a system for electronic monitoring according to an exemplary embodiment of the present invention will be described. FIG. 1 is a diagram showing a system for electronic monitoring according to an exemplary embodiment of the present invention.

As shown in FIG. 1, a system for electronic monitoring 100 according to an exemplary embodiment of the present invention is linked with a plurality of packet communication systems, that is, a first communication system 10 and a second communication system 20, according to requests for electronic monitoring of objects to perform electronic monitoring of monitoring object terminals 11 that are evaluated as monitoring object terminals. To this end, a system for electronic monitoring 100 includes an electronic monitoring controller 110, and a plurality of electronic monitoring units, that is, a first electronic monitoring unit 130 and a second electronic monitoring unit 150.

The electronic monitoring controller 110 transmits the electronic monitoring instructions to the first electronic monitoring unit 130 or the second electronic monitoring unit 150 based on an electronic monitoring database, and performs the electronic monitoring based on data packets received from the first electronic monitoring unit 130 or the second electronic monitoring unit 150.

The first electronic monitoring unit 130 performs the electronic monitoring on a plurality of packets that are transmitted through the plurality of terminals connected to the first communication system 10 and the first communication system 10 according to electronic monitoring instructions transmitted from the electronic monitoring controller 110. At this time, the first electronic monitoring unit 130 can perform the electronic monitoring based on a deep packet inspection (hereinafter referred to as “DPI”) that is a network packet filter technology for inspecting the heads or entire contents of all packets that pass through specific inspection points.

The second electronic monitoring unit 150 performs the electronic monitoring on a plurality of packets that are transmitted through the plurality of terminals connected to the second communication system 20 and the second communication system 20 according to electronic monitoring instructions transmitted from the electronic monitoring controller 110. The second electronic monitoring unit 150 can perform the electronic monitoring based on the DPI technology.

The electronic monitoring controller 110, the first electronic monitoring unit 130, and the second electronic monitoring unit 150 can each correspond to a computer or a server that operates management software.

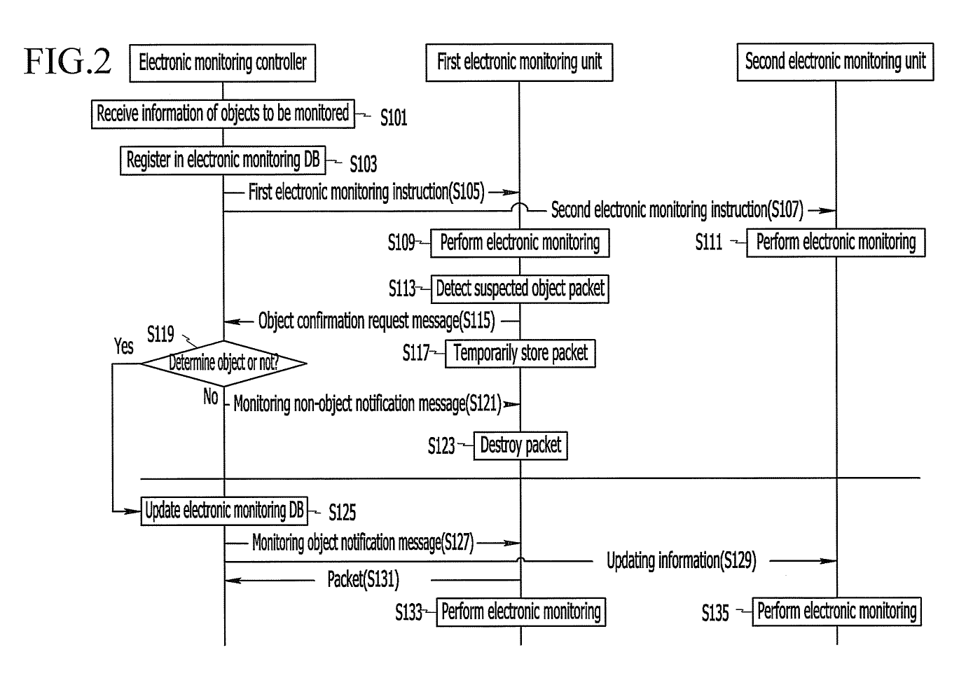

Next, a method for performing electronic monitoring of a system for electronic monitoring according to an exemplary embodiment of the present invention will be described with reference to FIG. 2.

FIG. 2 is a diagram showing a method for performing electronic monitoring according to an exemplary embodiment of the present invention.

As shown in FIG. 2, the electronic monitoring controller 110 receives the information on objects to be monitored from a law enforcement agency (S101). At this time, the information on objects to be monitored may include identification information of the monitoring object terminals 11. In addition, the identification information on the monitoring object terminals 11 may include the name, date of birth, resident registration number, recognition ID, address, telephone number, etc., of an electronic monitoring object.

Next, the electronic monitoring controller 110 registers the information of objects to be monitored in the electronic monitoring database (hereinafter referred to as “DB”) (S103).

Thereafter, the electronic monitoring controller 110 transmits the first electronic monitoring instruction, which instructs the performance of the electronic monitoring according to the information of objects to be monitored, to the first electronic monitoring unit 130 (S105). The first electronic monitoring instruction may include the information on objects to be monitored.

Further, the electronic monitoring controller 110 transmits the second electronic monitoring instruction, which instructs the performance of the electronic monitoring according to the information of objects to be monitored, to the second electronic monitoring unit 150 (S107). The second electronic monitoring instruction may include the information on objects to be monitored.

Next, the first electronic monitoring unit 130 performs the electronic monitoring on the plurality of packets that are transmitted through the plurality of terminals connected to the first communication system 10 and the first communication system 10 according to the first electronic monitoring instruction (S109).

Further, the second electronic monitoring unit 150 performs the electronic monitoring on the plurality of packets that are transmitted through the plurality of terminals connected to the second communication system 20 and the second communication system 20 according to the second electronic monitoring instruction (S111).

When the first electronic monitoring unit 130 detects suspect object packets corresponding to a packet that is suspected as being communicated by the monitoring object terminals 11 using forgery or false-name ID or a packet that includes the information on the monitoring object terminals 11 among the communication contents, based on the information of objects to be monitored (S113), it transmits object confirmation request messages that request whether the terminals (hereinafter referred to as “suspect object terminals”) that transmit and receive the suspect object packets corresponds to the monitoring object terminals 11 to the electronic monitoring controller 110 (S115). At this time, the object confirmation request messages include the information on the suspect object packets.

The first electronic monitoring unit 130 then temporarily stores the suspect object packets (S117).

Next, the electronic monitoring controller 110 determines if they are the monitoring objects or not according to the information on the suspect object packets (S119). The electronic monitoring controller 110 can determine whether the suspect object terminals correspond to the monitoring object terminals 11 according to the information on the suspect object packets based on the electronic monitoring database. Further, the electronic monitoring controller 110 can request the determination of the objects or not from the law enforcement agency.

When the suspect object terminals are not the monitoring objects, the electronic monitoring controller 110 transmits monitoring non-object notification messages, which notify that the suspect object terminals are not the monitoring objects, to the first electronic monitoring unit 130 (S121).

Thereafter, the first electronic monitoring unit 130 destroys the temporarily stored suspect object packets (S123). After first electronic monitoring unit 130 destroys the temporarily stored packets, it can perform the electronic monitoring according to the first electronic monitoring instructions.

Meanwhile, when the suspect object terminals are the monitoring object terminals 11, the electronic monitoring controller 110 updates the electronic monitoring database based on the information on the suspect object packets (S125). The electronic monitoring controller 110 registers the additional identification information of the monitoring object terminals 11 in the electronic monitoring database based on the information on the suspect object packets, making it possible to update the electronic monitoring database. The additional identification information on the monitoring object terminals 11 may include the false-name ID information on the electronic monitoring objects.

Thereafter, the electronic monitoring controller 110 transmits the monitoring object notification messages, which notify that the suspect object terminals are the monitoring object terminals 11, to the first electronic monitoring unit 130 (S127). The monitoring object notification messages may include the additional identification information on the monitoring object terminals 11.

Also, the electronic monitoring controller 110 transmits the update information on the electronic monitoring database to the second electronic monitoring unit 150 (S129). The update information may include the additional identification information on the monitoring object terminals 11.

Next, the first electronic monitoring unit 130 transmits the temporarily stored suspect object packets to the electronic monitoring controller 110 (S131).

Thereafter, the first electronic monitoring unit 130 performs the electronic monitoring on the packets that are transmitted through the plurality of terminals connected to the first communication system 10 and the first communication system 10 according to the first electronic monitoring instructions and the additional identification information on the monitoring object terminals 11 (S133).

In addition, the second electronic monitoring unit 150 performs the electronic monitoring on the packets that are transmitted through the plurality of terminals connected to the second communication system 20 and the second communication system 20 according to the second electronic monitoring instructions and the additional identification information on the monitoring object terminals 11 (S135).

Thereby, the electronic monitoring controller 110 can perform the continuous electronic monitoring for the monitoring object terminals 11 even when the monitoring object terminals 11 change the communication system or perform the communication through the false-name ID.

With the embodiment of the present invention, the electronic monitoring can be performed using the communication information on the packets transmitted from the packet communication system to perform the continuous electronic monitoring even when the objects to be monitored change the communication systems or performs communications using false-name IDs.

The above-mentioned exemplary embodiments of the present invention are not embodied only by an apparatus and/or method. Alternatively, the above-mentioned exemplary embodiments may be embodied by a program performing functions that correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for performing electronic monitoring on a terminal by a system,
wherein the system includes a plurality of monitoring servers that monitor a control server and a plurality of communication systems, respectively,
the method for performing electronic monitoring comprising:
transmitting an electronic monitoring instruction including identification information on the terminal to be monitored to each of the plurality of monitoring servers by the control server based on information on monitoring objects stored in a database;
receiving an object confirmation request message including information on a suspect object packet from a first monitoring server of the plurality of monitoring servers by the control server;
determining whether the terminal corresponds to a suspect object terminal that transmits or receives the suspect object packet according to the object confirmation request message by the control server based on the information on the monitoring objects; and
when the suspect object terminal is the terminal, updating the database by the control server based on the information on the suspect object packet.

2. The method for performing electronic monitoring of claim 1, further comprising:
transmitting monitoring object notification messages notifying that the suspect object terminal is the terminal to the first monitoring server by the control server; and
receiving the suspect object packets from the first monitoring server by the control server.

3. The method for performing electronic monitoring of claim 2, wherein
the updating includes
registering additional identification information on the terminal in the databased and updating the database by the control server based on the information on the suspect object packet, and
the suspect object notification message includes the additional identification information on the terminal.

4. The method for performing electronic monitoring of claim 3, further comprising
transmitting the additional identification information on the terminal to the plurality of monitoring servers by the control server.

5. The method for performing electronic monitoring of claim 1, further comprising,
when the suspect object terminal is not the terminal, transmitting a monitoring non-object notification message notifying that the suspect object terminal is not the terminal to the first monitoring server by the control server.

6. A method for performing electronic monitoring on a terminal by a system,
wherein the system includes a plurality of monitoring servers that monitor a control server and a plurality of communication systems, respectively,
the method for performing electronic monitoring comprising:
receiving an electronic monitoring instruction including the identification information on the terminal to be monitored from the control server by a first monitoring server of the plurality of monitoring servers;
performing the electronic monitoring on a plurality of packets transmitted through a plurality of terminals accessing a first communication system of a plurality of communication systems and the first communication system according to the electronic monitoring instruction by the first monitoring server to detect a suspect object packet;
sending an object confirmation request message including the information on the suspect object packet to the control server by the first monitoring server and requesting to the control server whether the suspect object terminal transmitting or receiving the suspect object packet corresponds to the terminal; and
when receiving the monitoring object notification message from the control server, transmitting the suspect object packet to the control server by the first monitoring server.

7. The method for performing electronic monitoring of claim 6, wherein
the monitoring object notification message
includes the additional identification information on the terminal, and
wherein the method for performing electronic monitoring further includes
performing the electronic monitoring according to the electronic monitoring instruction and the additional identification information of the terminal by the first monitoring server.

8. The method for performing electronic monitoring of claim 6, wherein
the detecting
includes temporarily storing the suspect object packet, and
the method for performing electronic monitoring further includes
destroying the temporarily stored suspect object packet by the first monitoring server when receiving a monitoring non-object notification message from the control server.

9. The method for performing electronic monitoring of claim 6, wherein
the suspect object packet is a packet that is suspected as being communicated by the terminal using forgery or false-name ID or a packet that includes the information on the terminal among the communication contents.

10. A system for performing electronic monitoring according to information of an object to be monitored, the system for performing electronic monitoring comprising
a plurality of electronic monitoring apparatuses that correspond to each of the plurality of communication systems and perform the electronic monitoring according to the information of object to be monitored based on a deep packet check technology,
wherein any one of the plurality of electronic monitoring apparatuses
performs the electronic monitoring on the plurality of packets transmitted through a plurality of terminals accessing any one of a plurality of communication systems and the communication systems.

11. The system for performing electronic monitoring of claim 10, further comprising
a control device that registers the information of objects to be monitored in the database, transmits the information of object to be monitored to each of the plurality of electronic monitoring apparatuses, and updates the database based on information on a suspect object packet received from any one of the plurality of electronic monitoring apparatuses.
